(19) United States
(12) Patent Application Publication
(10) Pub. No.: US 2024/0240015 A1
(43) Pub. Date: Jul. 18, 2024

(54) BLOWN FILM ARTICLE OF PHA AND WAX ADDITIVES

(71) Applicant: Plastic Suppliers, Inc. dba Earthfirst, COLUMBUS, OH (US)

(72) Inventor: Tom Bowden, Columbus, OH (US)

(21) Appl. No.: 18/414,431

(22) Filed: Jan. 16, 2024

Related U.S. Application Data
(60) Provisional application No. 63/439,020, filed on Jan. 13, 2023.

(51) Int. Cl. C08L 67/04; C08J 5/18; C08K 3/36; C08K 5/20

(52) U.S. Cl. CPC C08L 67/04; C08J 5/18; C08K 3/36; C08K 5/20; C08J 2367/04; C08J 2467/04; C08L 2203/16; C08L 2205/025; C08L 2205/03; C08L 2205/06

(57) ABSTRACT

A compostable blown film article that includes PHA produced in an enclosed blown film process. The blown film may include a wax additive that reduces the stickiness of the film.

### CROSS-REFERENCE TO RELATED APPLICATIONS

This application claims priority to U.S. Provisional Application No. 63/439,020 entitled “BLOWN FILM ARTICLE OF PHA AND WAX ADDITIVES”, filed Jan. 13, 2023, the entire contents of which are incorporated by reference herein.

### FIELD OF THE DISCLOSURE

The present disclosure is generally related to a polyhydroxyalkanoate (PHA) blown film with a blend of PHA and other biopolyesters and additives. Specifically, the PHA blown film may comprise a PHA blend base, a slip additive, an antiblock additive, a processing aid additive, and a wax additive, wherein the PHA blown film is produced in an enclosed climate-controlled blown film process.

### BACKGROUND

Current biopolymer blown films such as polylactic acid (PLA) have desirable characteristics but are only compostable in industrial facilities. This limits the marketability of such films as well and raises the environmental impact.

PHA is a biopolymer that is more compostable when compared to PLA. PHA can be composted under home composting condition.

PHA has a tendency to be very sticky, and it can be difficult to separate resulting blown films, lowering the usefulness of the film.

### SUMMARY OF THE INVENTION

Provided herein is a biopolymer blown film comprising PHA. Specifically, the blown film comprises a polyhydroxyalkanoate (PHA) blend base that includes PHA and one or more other biopolyesters, wherein the PHA blend base includes more PHA than the other biopolyesters. The blown film also includes a wax. The blown film may additionally comprise one or more of a slip additive that reduces friction of the film, an antiblock additive, and a processing aid additive that reduces friction on a surface of the film. The blown film may include at least one biopolyester selected from the group consisting of polylactic acid (PLA), poly(L-lactic acid) (PLLA), poly(D-lactic acid) (PDLA), poly(D,L-lactic acid) (PDLLA), PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives and combinations thereof. The at least one other biopolyester may be included in the PHA blend base in an amount of no more than about 50% by weight of the blend base. The blown film may further comprise a plasticizer in an amount of less than about 2% by weight of the blown film, or the blown film may be free of a plasticizer.

### BRIEF DESCRIPTION OF THE DRAWINGS

FIG. 1 illustrates a system for making a PHA blown film.

FIG. 2 illustrates a PHA blown film.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The PHA films described herein overcome the problems related to PHA's limited usefulness due to the stickiness of the film. By adding wax or a slip additive to the PHA film the stickiness is reduced, thus allowing for a more useful film. Furthermore, most PLA films are not easily compostable or are only compostable in industrial facilities, whereas a PHA film is easily composted and can be composted under home composting conditions. To further improve the film, the PHA film of the present disclosure may be produced in an enclosed blown film process. The wax or slip additive prevents the collapsed layer of the blown film from sticking together. Furthermore, the wax or slip additive helps with heat sealing by not sticking to jaws of sealer. The enclosed process allows for more control during the manufacturing process, specifically during the cooling of the blown film. The enclosed process reduces defects and inconsistencies in the PHA film.

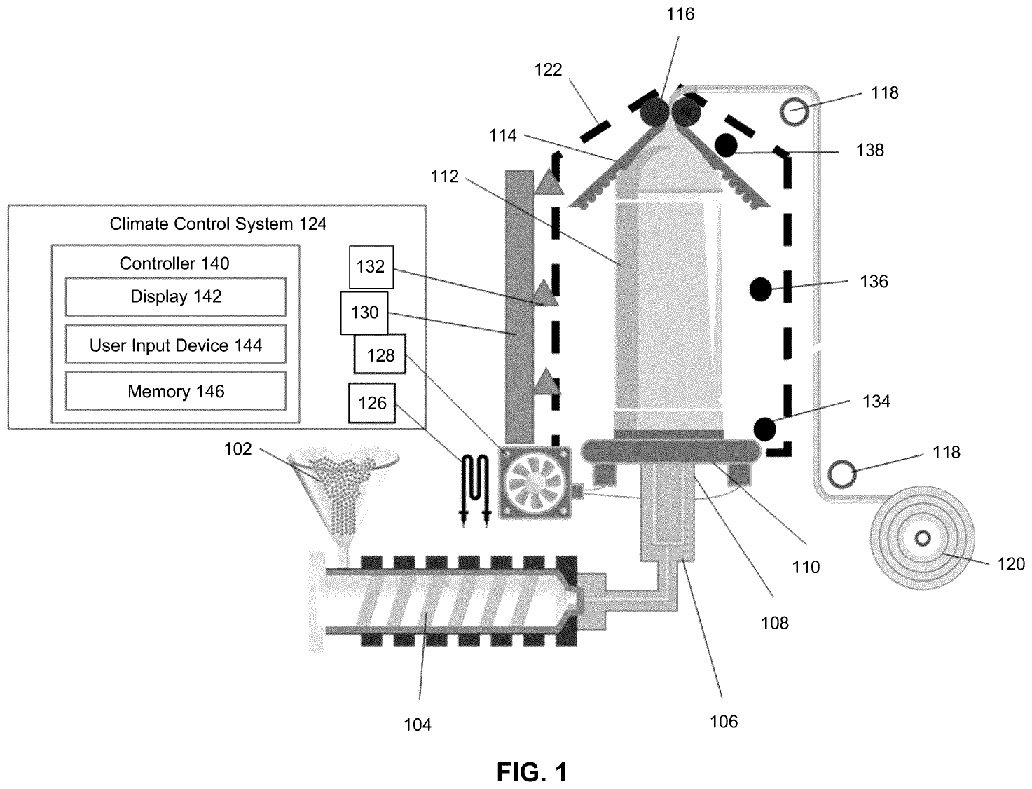

FIG. 1 shows a system for producing a PHA blown film. This system comprises a hopper 102, a container for bulk polymer material such as polymer pellets, beads, or grains, which tapers downward to a discharge point at the bottom where the bulk material is discharged into an extruder 104. The bulk polymer material may be dried in a variety of different ways. In one embodiment, the hopper may include a dehumidifying element, such as a dehumidifying hopper with hot air at a relatively low dew point may be used. However, a variety of air dryers are known in the art and many of them may be suitable for drying. The present invention need not be limited to air dryers only but may include other types of dryers, including baking ovens. A dehumidifying hopper may be desirable in some embodiments in that dehumidified air passes through a bed of the bulk polymer material to extract moisture from the resin. The hopper 102 may include a desiccant bed. A desiccant material such as silica, absorbs moisture from the circulating air. Dual desiccant bed systems are common, so that one bed is on-stream while the stand-by bed is being regenerated. Either a time cycle or a predetermined decrease in air dew point is used to shift airflow from one bed to the other. Such methodology may remove some moisture that may reside below the surface of the bulk polymer material in addition to the surface moisture.

A moisture content of less than 0.04% (400 ppm) is recommended to prevent viscosity degradation during processing. The bulk polymer material may not be exposed to atmospheric conditions after drying, and the hopper may be kept sealed until ready to use. In some embodiments a moisture content of less than about 200 ppm is preferable, and less than about 50 ppm, more preferable (measured by the Karl Fisher method).

The extruder 104 receives bulk material, such as bulk polymer material from the hopper 102. The extruder 104 then extrudes the material through an annular die 108. During the extrusion process, the bulk polymer material is melted and homogenized before it is pumped through an annular die 108. The bulk polymer material is melted into a low viscosity molten mass, thus combining the heretofore individual polymer pellets, beads or grains into one molten mass. The viscosity of the melt will depend on the temperature. Temperatures can range from about the temperature at which the polymers/biopolymers will remain melted to about the temperature where degradation of the polymers/biopolymers begins to occur. By way of example, extrusion melt temperatures may be maintained between about 2900 F to about 3950 F for PHA blends, but may ultimately depend on the different polymers that have been blended and their respective melting points.

A polymer cooler 106 may be included to increase the viscosity of the molten polymers, which makes the melt manageable for further processing. A cooling step is not necessarily required due to the use of a climate control system 124, but in some embodiments the cooling step maybe implemented. By way of example, the viscosity of PHA at about 3380 F and an apparent sheer rate of about 5.5 seconds⁻¹ in a capillary rheometer may range from about 1,000 poise (P, dyne/cm²) to about 8,000 P, preferably about 3,000 P to about 6,000 P, and more preferably, about 4,500 P. At a shear rate of about 55 seconds⁻¹, the same polymer at about 4800 F may have an apparent viscosity that ranges from about 1,000 P to about 5,000 P, preferably about 2,000 P to about 4,000 P, and more preferably, about 3,000 P. The cooling allows for the temperature of the extruded polymer to drop to a level at which the corresponding viscosity is high enough to allow a bubble to be blown. By increasing the viscosity, a smoother film surface than without this step may be generated. A smoother surface aids in the printing process that is performed in many end applications, such as, for example, labels.

The polymer cooler 106 may include any cooler (i.e., heat exchanger) known in the art. The cooling medium may include air, liquids, or a polymeric coolant. For example, the viscosity of the polymer melt may be adjusted, alone or in combination, for example, by air cooling the die inner mandrel through which the polymer film is blown, the use of viscosity enhancers noted below, controlling the die temperature with air or liquids, or polymer coolers.

In another embodiments, the polymer cooler 106 operating temperature range may be between about 290° F to about 395° F. Higher temperatures may be used, but such higher temperatures may also contribute to the degradation of the polymer. The temperature and duration of cooling may depend on both the amount of polymer being cooled and the film properties that may be desired. In an embodiment involving polystyrene cooling, the pressure in the primary loop is generally about 1000 psi to about 7,000 psi. The pressure in the same loop adjusted for PHA use may range from about 300 psi to about 4,000 psi.

In one example, the viscosity of PLA at 320°-360° F. and an apparent sheer rate of about 5.5 seconds⁻¹ in a capillary rheometer, may range from about 15,000 P to about 17,000 P, preferably about 15,500 P to about 16,500 P, and more preferably, about 16,000 P. At a shear rate of about 55 seconds⁻¹ the same polymer at 375° F. may have an apparent viscosity that ranges from about 14,000 P to about 16,000 P, preferably about 16,500 P to about 15,500 P, and more preferably, about 15,000 P. The polymer cooling step can increase the viscosity from anywhere from about 2 to about 10 times that of the polymer coming out of the extruder.

The annular die 108 is used for the shaping of polymer products, such as in a pipe extrusion process, extrusion blow molding process, and blown film extrusion process. In this part of the system, the polymer melt is already pre-cooled, preferably in a polymer cooler 106, and then submitted to a blown film orientation process. However, the viscosity of the polymer melt may also be adjusted, alone or in combination, for example, by air cooling the annular die 108 inner mandrel, the use of viscosity enhancers, and liquid thermoregulation of the annular die 108. In another embodiment a pre-cooling step may be implemented but is not necessary.

The system of the present invention has at least one significant advantage in that a very controlled temperature—from the post extrusion temperature conditioning—can be achieved prior to the formation of a bubble. A blown film extrusion process extrudes molten polymer through the annular die 108 of circular cross-section and uses an air jet to inflate a bubble comprising the same.

The annular die 108 parameters may range from 1:0.75 BUR (Blown Up Ratio) to about 1:7.0 BUR, and preferably, about 1:4 BUR in the cross-web direction. In the length (or machine) direction, annular die 108 parameters may range from about 1:1 drawdown ratio to about 1:300 drawdown ratio, and preferably, about 1:130 drawdown ratio. Orienting temperatures of the systems of the present disclosure may range from about 1000 F to about 1600 F, and more preferably, about 130° F.

An air ring 110 is used to fine-tune temperatures at the base of the polymer film bubble 112. In a preferred embodiment then, by virtue of pre-cooling the melted polymer, only a final fine-tuning of orienting temperature is performed, where desired, during the orientation process. In other words, the greater share of temperature conditioning takes place prior to orienting and not during orienting. Where a fine-tuning of temperature is desired, it can be relatively easily accomplished by a temperature-controlled air ring 110, which blows chilled air at the base of the bubble 112. As the molten polymer is extruded through the annular die 108, or of circular cross-section, and uses an air jet to inflate a bubble 112.

Once the extrudate has been inflated into a circular bubble 112, it then is “collapsed” into a double thickness film. The collapsing process is performed by use of an “A-frame,” also known as a collapsing frame 114. The collapsing frame 114 uses primary nip rollers 116, panels, and/or flat sticks to flatten the bubble 112 into a sheet of double-thickness film. The sheets are ultimately cut and wound onto two finished rolls, or coils, or winder rollers 120 of PHA film. The sheets of film may also be cut to a desired length.

The primary nip rollers 116 flatten the bubble into a sheet of double-thickness film. In one embodiment the primary nip rollers 116 may be placed and designed in such a way that they do not allow any air to pass through. The primary nip rollers 116 may be placed at the very top of the enclosure 122 when the film process is oriented in an upward direction. By limiting air from escaping through the primary nip rollers 116 the internal temperature of the enclosure can be controlled better.

Secondary nip rollers 118 are located after the primary nip rollers 116 to assist with moving the film along the line. In another embodiment, additional nip rollers may be used to further assist in moving the fill along the production line.

The winder rolls 120, coils, or winds the collapsed film after coming through the secondary nip rollers 118.

The enclosure 122 is a casing or exterior shell outside that encloses the film process. The enclosure 122 encases the film blowing process from the annular die up to the primary nip rollers 116. The enclosure 122 surrounds the blown film tower and includes one or more heating/cooling elements 126 to maintain an optimal temperature for the blown film process. In another embodiment, the enclosure 122 does not encase the entire film blowing process but starts just after the bubble 112 is formed and encases the process up to the primary nip rollers 116. In another embodiment, the enclosure 122 is separated into several zones where the temperature in each zone is monitored and controlled separately in each zone by temperature sensors (134, 136, 138), air ducts 130 and air vents 132.

The climate control system 124 is used to maintain optimal temperatures within the enclosure. The climate control system 124 includes the heating/cooling elements 126, a blower 128, air ducts 130, air vents 132, a first temperature sensor 134, a second temperature sensor 136, a third temperature sensor 138, and a controller 140. The climate control system 124 may be located outside of the enclosure 122.

The heating/cooling element 126 may include a heating electric coil or use other means of heating air. In another embodiment, there are at least two heating/cooling elements 126, which allows the climate control system 124 to control the temperature of the air moving to different sections of the enclosure 122. A heating/cooling element 126 for each temperature sensor may be included to allow for individual control of temperature to each section of the enclosure where each temperature sensor is located. By controlling the climate within the enclosure 122 to maintain a preferred operating temperature, the film production can be improved.

The blower 128 moves heated air from the heating/cooling element 126 through the air ducts 130 and air vents 132 to different sections of the enclosure. In another embodiment, there are at least two blowers 128. In another example, the system may include one blower 128 for each of the temperature sensors so that air can be individually forced or routed to the area of each temperature sensor.

The air ducts 130 channel heated from the heating/cooling element 126 and blower 128 to different portions of the enclosure 122. This allows for heated forced air to be distributed and directed to different sections of the enclosure 122 to ensure ideal temperature control throughout the enclosure 122. The air vents 132 open from the air ducts 130 and help direct and regulate the airflow into the enclosure. The air vents 132 may be controlled by the controller 140 to help direct airflow by opening and closing the air vents or directing the airflow.

The first temperature sensor 134 monitors temperature within the enclosure 122. A temperature sensor is an electronic device that measures the temperature of its environment and converts the input data into electronic data to record, monitor, or signal temperature changes. There are many different types of temperature sensors. Some temperature sensors require direct contact with the physical object that is being monitored (contact temperature sensors), while others indirectly measure the temperature of an object (non-contact temperature sensors). The first temperature sensor 134 is one of at least three sensors that are located at a different point within the enclosure 122. In one embodiment the first temperature sensor 134 is located just above the air ring 110 but before the bubble 112 is fully formed. The first temperature sensor 134 monitors the temperature within the enclosure 122 just above the air ring 110. The monitored temperature electrically communicated (e.g., wired or wirelessly, including WiFi, Bluetooth, or other transmission mediums) to the controller 140 which uses the temperature data to regulate air temperature within the enclosure 122 at the location.

The second temperature sensor 136 monitors temperature within the enclosure 122. The second temperature sensor 136 is one of at least three sensors that are located at a different point within the enclosure 122. In one embodiment the second temperature sensor 136 is located at a mid-point of the enclosure 122. In another embodiment where the enclosure 122 doesn't fully enclose the process down to the air ring 110, the second temperature sensor 136 may be located at a point just as the bubble 112 enters the enclosure 122. The second temperature sensor 136 monitors the temperature and the monitored temperature is electrically communicated electrically communicated (like that of sensor 134) to the controller 140 which uses the temperature data to regulate air temperature within the enclosure 122 at the location of the second temperature sensor 136.

The third temperature sensor 138 monitors temperature in the enclosure 122. The third temperature sensor 138 is one of at least three sensors that are located at a different point within the enclosure 122 along the film blowing process. In one embodiment the third temperature sensor 138 is located just before the primary nip rollers 116 just before the bubble is collapsed 122. The third temperature sensor 138 monitors the temperature within the enclosure 122 just before the primary nip rollers 116. The monitored temperature is sent back to the controller 140 which uses the temperature data to regulate air temperature within the enclosure 122 at the location of the third temperature sensor 138.

The 140 controller includes a display 142, a user input device 144 or user interface, and a memory 146. The controller 140 is used to program and control the climate control system 124. A user may select pre-stored settings or enter in a specific setting and the controller 140 then monitors the temperature data from the temperature sensors (134, 136, 138). Depending on the data received back from the sensors, the controller 140 may adjust the heat and airflow entering the enclosure 122 by adjusting the heating/cooling element 126, blower 128, and air vents 132. The display 142 is used to display data and user inputs. Displayed data may include, but are not limited to, sensor data, such as temperature, blower or fan speeds, or other data related to the film blowing process.

The user input device 144 or user interfaces are well known in the art and may include, but are not limited to, keyboards, touch screens, voice, or other connected devices, such as smartphones or tablets.

The memory 146 is a device or system that is used to store information for immediate use in a computer or related computer hardware and digital electronic devices. The term memory is often synonymous with the term primary storage or main memory. The memory 146 stores data from the sensors and other devices connected to the film blowing process. Furthermore, the memory 146 stores user input information from the user input device 144, a preset configuration such as temperature ranges or thresholds, and executable code or modules.

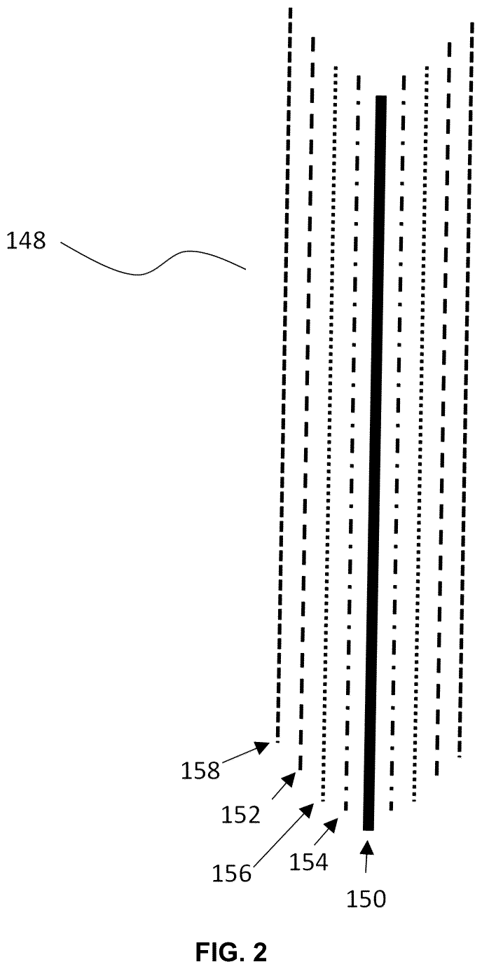

FIG. 2 illustrates an exemplary PHA blown film 148. The blown film 148 of FIG. 2 includes a wax additive that helps reduce the stickiness of the PHA film. The PHA film may comprise a 150 PHA blend base, a 152 slip additive, a 154 anti-block, a 156 processing aid, and a 158 wax. PHA blown films alone are often much too sticky and unmanageable, limiting their use and marketability. Furthermore, the 148 PHA blown film benefits from the previously described enclosed blown film process. The enclosed blown film process allows for a climate-controlled process where the temperature during the blowing and cooling processes can be controlled allowing a higher quality finished product with fewer defects or inconsistency as compared to a PHA blown film consisting of PHA alone. Since different elements of the PHA blown film may have different cooling temperatures or different cooling rates can improve the cohesion of the composition, an enclosed system would greatly benefit the production of the film. The resulting film is an improvement on other similar films as it is flexible, allows for elongation, has significant clarity, ductility, stability, is the appropriate thickness for packaging, home or marine compostable, heat-stable (i.e. can be printed), differential temperatures (i.e. has sealing characteristics), and allows for jaw release (the result of slip additive).

The PHA blend base may include a blend base of PHA and at least one additional polyester selected from polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or blends/mixtures thereof. The PHA blend may comprise no more than 50 wt % of the additional biopolyester, such as about 50 wt %, about 40 wt %, about 30 wt %, about 20 wt %, about 10 wt %, about 5 wt %, about 1 wt %, or about 0.1 wt % of the additional biopolyester. In some embodiments, a PHA base containing no additional biopolyesters may be used. In some embodiments, the PHA blend base includes PLA.

The 152 slip additives are used to reduce friction between films and between film and converting equipment, which improves movement through extrusion lines and downstream rollers and packaging operations and enhances processing or end applications. Fatty acid amides, including primary and secondary amides, are the most commonly used slip additives. Similar to external lubricants, they migrate or bloom to the surface where they form a microcrystalline structure that decreases friction. Primary, unsaturated fatty acid amides such as erucamide and oleamide migrate quickly. Secondary amides, for example, oleyl palmitamide, are less volatile at the higher process temperatures with very slow migration rates. The previously described enclosed blown film process may further enhance the migration of the slip additive as the enclosure creates an enclosed climate-controlled environment, allowing for ideal conditions for migration of the slip additives. In one embodiment, the slip additive may include a wax additive providing multiple benefits for the PHA blown film.

Antiblock additives are often used in films with marginal blocking performance. One example of an antiblock additive includes silica. There are some benefits between adding antiblock agents such as silica and slip agents. Adding silica not only reduces blocking but allows less slip to be added to achieve the target coefficient of friction. Some types of additives, such as calcium carbonate, have been found to absorb slip agents, increasing the coefficient of friction. High levels of silica and other inorganic additives can result in a high haze. This can be alleviated by confining the inorganic additives to a thin outer layer. Furthermore, by limiting to a thin outer layer will help with clarity. Inorganic additives have also been reported to react with some slip agents, resulting in degradation by-products with color or odor/taste issues.

The 156 processing aids lower the surface friction of films, allowing the film to be rapidly extruded and then shipped or stored in rolls. Alternatively, they also allow the resin to be converted easily in blown-film processes or thermoforming processes. Processing aids refer to several different classes of materials used to improve processability and handling. One such example of a 156 processing aid is Polyethylene glycol (PEG). Other low molecular weight polyethylene glycols might be used.

The 158 wax is an additive to the 148 PHA blown film which reduces the stickiness of the 148 PHA blown film. The 158 wax additive may include, but is not limited to, an EBS (ethylene-bis staramide) synthetic wax. In one embodiment the 158 wax may also be the 152 slip additive and provide benefits for both reduced stickiness and reduced friction or the blown film.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

### ENUMERATED EMBODIMENTS

Embodiment 1: A blown film comprising a polyhydroxyalkanoate (PHA) blend base that includes PHA and one or more other biopolyesters, wherein the PHA blend base includes more PHA than the other biopolyesters; and a wax.

Embodiment 2: The blown film of embodiment 1, wherein the wax comprises EBS (ethylene-bis staramide) synthetic wax.

Embodiment 3: The blown film of embodiment 1 or 2, further comprising one or more of a slip additive that reduces friction of the film, an antiblock additive, and a processing aid additive that reduces friction on a surface of the film.

Embodiment 4: The blown film of any one of embodiments 1-3, wherein the at least one other biopolyesters is selected from the group consisting of polylactic acid (PLA), poly(L-lactic acid) (PLLA), poly(D-lactic acid) (PDLA), poly(D,L-lactic acid) (PDLLA), PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives and combinations thereof.

Embodiment 5: The blown film of embodiment 4, wherein the at least one other biopolyester includes PLA.

Embodiment 6: The blown film of any one of embodiments 1-5, wherein the at least one other biopolyester is included in the PHA blend base in an amount of no more than about 50% by weight of the blend base.

Embodiment 7: The blown film of any one of embodiments 1-6, further comprising a plasticizer in an amount of less than about 2% by weight of the blown film.

Embodiment 8: The blown film of any one of embodiments 1-7, wherein the blown film is free of a plasticizer.

Embodiment 9: The blown film of embodiment 3, wherein the slip additive is selected from the group consisting of oleamide, erucamide, stearamide, behenamide, oleyl palmitamide, stearyl erucamide, ethylene bis-oleamide, N,N′-Ethylene Bis(Stearamide) (EBS), and any combination thereof.

Embodiment 10: The blown film of embodiment 3, wherein the antiblock additive comprises silica.

Embodiment 11: The blown film of embodiment 3, wherein the processing aid comprises a viscosity enhancer.

Embodiment 12: The blown film of embodiment 3, wherein the processing aid comprises polyethylene glycol.

What is claimed is:

1. A blown film comprising:
a polyhydroxyalkanoate (PHA) blend base that includes PHA and one or more other biopolyesters, wherein the PHA blend base includes more PHA than the other biopolyesters; and
a wax.

2. The blown film of claim 1, wherein the wax comprises EBS (ethylene-bis staramide) synthetic wax.

3. The blown film of claim 1, further comprising one or more of a slip additive that reduces friction of the film, an antiblock additive, and a processing aid additive that reduces friction on a surface of the film.

4. The blown film of claim 1, wherein the at least one other biopolyesters is selected from the group consisting of polylactic acid (PLA), poly(L-lactic acid) (PLLA), poly(D-lactic acid) (PDLA), poly(D,L-lactic acid) (PDLLA), PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives and combinations thereof.

5. The blown film of claim 4, wherein the at least one other biopolyester includes PLA.

6. The blown film of claim 1, wherein the at least one other biopolyester is included in the PHA blend base in an amount of no more than about 50% by weight of the blend base.

7. The blown film of claim 1, further comprising a plasticizer in an amount of less than about 2% by weight of the blown film.

8. The blown film of claim 1, wherein the blown film is free of a plasticizer.

9. The blown film of claim 3, wherein the slip additive is selected from the group consisting of oleamide, erucamide, stearamide, behenamide, oleyl palmitamide, stearyl erucamide, ethylene bis-oleamide, N,N′-Ethylene Bis(Stearamide) (EBS), and any combination thereof.

10. The blown film of claim 3, wherein the antiblock additive comprises silica.

11. The blown film of claim 3, wherein the processing aid comprises a viscosity enhancer.

12. The blown film of claim 3, wherein the processing aid comprises polyethylene glycol.
